(19) United States
(12) Patent Application Publication
(10) Pub. No.: US 2024/0162429 A1
(43) Pub. Date: May 16, 2024

(54) NEGATIVE ELECTRODE COMPRISING AN ELECTROCHEMICALLY ACTIVE ZINC MATERIAL

(71) Applicant: SAFT, Levallois-Perret (FR)

(72) Inventors: Mélanie VILLALOBOS, SMARVES (FR); Anaîs BERTHELLEMY, POITIERS (FR); Tanalou BOURA, COMPIEGNE (FR)

(73) Assignee: SAFT, Levallois-Perret (FR)

(21) Appl. No.: 18/281,407

(22) PCT Filed: Mar. 9, 2022
(86) PCT No.: PCT/EP2022/055994

§ 371 Date: Sep. 11, 2023

(30) Foreign Application Priority Data
Mar. 12, 2021 (FR) 2102475

(51) Int. Cl. H01M 4/42; H01M 4/02; H01M 4/24; H01M 10/32

(52) U.S. Cl. CPC H01M 4/42; H01M 4/24; H01M 10/32; H01M 2004/021

(57) ABSTRACT

A paste electrode comprising a current collector support, which is coated on at least one of its faces with a coating composed of a composition comprising an active material comprising an alloy of zinc with one or more chemical elements, and one or more binders. This electrode may be used as an anode of an electrochemical cell comprising alkaline electrolyte. The coating contains at most 0.5% by mass of mercury or mercury compound. The electrode in spite of this presents effective resistance to corrosion by the electrolyte.

### TECHNICAL FIELD

The technical field of the present invention is that of plasticized negative electrodes comprising an electrochemically active zinc material, which may be used in an electrochemical cell comprising alkaline electrolyte. The technical field is also that of methods for preparing such electrodes.

### PRIOR ART

Secondary (rechargeable) electrochemical cells comprising an alkaline electrolyte and a negative electrode (anode) the electrochemically active material of which is based on zinc, are known from the state of the art. Zinc is not stable in acid or base aqueous medium. Indeed, it oxidizes in the presence of water, which leads to a loss of zinc and the formation of gas hydrogen according to the equation:

Zn+2H₂O→Zn(OH)₂+H₂(g)

This results in a gradual drop in the electrical performance of the electrochemical cell during its use.

It is known to incorporate mercury into the anode in order to limit the corrosion of the zinc. The presence of mercury imposes an overvoltage on the zinc electrode, which allows to limit, or even stop, the kinetics of corrosion of the zinc. However, mercury is toxic for the environment and for human beings because it attacks the brain, the kidneys and the nervous system. A way to reduce the corrosion rate of zinc by using as little mercury as possible is therefore sought.

To the Applicant's knowledge, there is no paste electrode based on zinc containing little or no mercury or mercury compound and which solves, or at least reduces, the problem of zinc corrosion.

Document U.S. Pat. No. 6,652,676 describes the manufacture of a paste based on an alloy of zinc, bismuth and indium. This alloy allows to avoid incorporating lead and mercury into the electrode. However, this paste is not deposited on the surface of a current collector but is poured into the internal volume of the container of an alkaline electrolyte cell. The anode current collector is not a metal strip but is a copper rod inserted into the paste to ensure electrical contact. The manufactured cell is of type AA, therefore of cylindrical format. As the current collector of the anode is a rod, its surface is too small to give the electrochemical cell a high power. Finally, the paste is prepared using potash and not water.

Document CN 111304959 describes the manufacture of an electrochemical cell comprising alkaline electrolyte without mercury. This cell comprises a separator made of a paper support covered with a coating. This coating is obtained by drying a paste which in turn is prepared by mixing polyacrylamide, polyvinyl alcohol, zinc chloride, an acid catalyst in solution, a solution of modified starch, an emulsifier and a zinc corrosion inhibitor. The paste obtained is therefore not deposited on a current collector but on a paper support, which is an electrical insulator.

Document U.S. Pat. No. 6,436,539 describes a method for preparing a dendritic powder of zinc alloyed with bismuth and/or indium, and optionally including lead, gallium or tin. These alloy elements allow to lower the rate of corrosion of zinc in a KOH medium. This document does not describe how this dendritic powder may be used to manufacture a paste which will be deposited on a current collector. This document does not describe a paste electrode.

Document EP 1683218 describes the preparation of a paste comprising a zinc alloy, carboxymethylcellulose, surfactants and potash. However, as for document U.S. Pat. No. 6,652,676, the manufactured cell is of cylindrical format and this paste is simply poured into the cylindrical space of the container of the electrochemical cell. This paste is not deposited on a current collector. The anode located in the center of the cell is a metal rod inserted into the paste to make electrical contact. The small surface of the anode current collector does not allow high power to be obtained. In addition, it is a primary electrochemical cell, therefore not rechargeable. Finally, the paste is prepared using potash and not water.

A secondary electrochemical cell comprising alkaline electrolyte capable of providing high power, for example greater than 1000 W/kg in the case of the AgO/Zn couple, and whose anode comprises at most 0.5% by mass of mercury or of mercury compound, is sought.

### SUMMARY OF THE INVENTION

To this end, the object of the invention is a paste electrode comprising a current collector support, which is coated on at least one of its faces with a coating composed of a composition comprising:
an active material comprising zinc alloyed with one or more chemical elements,
one or more binders.

It has been surprisingly discovered that it was possible to obtain a paste electrode based on zinc for a secondary electrochemical cell comprising alkaline electrolyte, using very little, or even no mercury or mercury compound in this electrode.

According to one embodiment, the mass of zinc alloy represents from 5 to 95% of the mass of the coating.

According to one embodiment, the mass of zinc alloy represents from 10 to 50%, preferably from 15 to 30% of the mass of the coating.

According to one embodiment, the active material further comprises zinc oxide ZnO.

According to one embodiment, the mass of zinc oxide represents from 90 to 50%, preferably from 70 to 85% of the mass of the coating.

According to one embodiment, the zinc oxide has a BET specific surface of at least 3 m²/g.

According to one embodiment, the coating contains at most 0.5% by mass of mercury or mercury compound.

According to one embodiment, the coating is free of mercury or mercury compound.

According to one embodiment, the coating results from the drying of a paste having a dynamic viscosity ranging from 30 Pa·s to 200 Pa·s for a temperature of 20° C. and at atmospheric pressure.

According to one embodiment, the zinc is alloyed with at least one element selected from the group consisting of lead, bismuth, indium, aluminum, gallium, tin and a mixture of several of these elements.

According to one embodiment, the binder is a cellulosic compound or a rubber of the styrene-butadiene type or a mixture of a cellulosic compound and a rubber of the styrene-butadiene type.

According to one embodiment, the coating further comprises at least one surfactant.

According to one embodiment, the coating comprises:
from 5 to 45% by mass of zinc alloy,
from 90 to 50% by mass of zinc oxide,
from 0.1 to 5% by mass of one or more binders.

According to one embodiment, the current collector support is a strip of copper or nickel-plated steel.

An object of the invention is also an electrochemical cell comprising an alkaline electrolyte, at least one cathode and at least one anode which is the paste electrode as defined above.

According to one embodiment, the cathode comprises at least one active material selected from the group consisting of silver, nickel, manganese dioxide and atmospheric oxygen.

According to one embodiment, the alkaline electrolyte comprises zinc oxide or tin or a mixture of both.

According to one embodiment, the container is of prismatic format.

### Presentation of Embodiments

The present invention relates to a paste electrode, also called plasticized or non-sintered electrode. According to the IEC 60050-482 standard, a paste electrode is an electrode in which the active material is applied in the form of a paste to a current-conducting collector. In the present invention, the paste electrode typically comprises a current-conducting collector on which is deposited a paste, which paste comprises a zinc alloy and at least one binder. The present invention therefore excludes negative electrodes which are not pasted or which are sintered, for example those made up of an expanded layer of zinc or of zinc deposited by electrolysis on a metal support.

The active material necessarily comprises zinc alloyed with one or more chemical elements. These chemical elements can be selected from the group consisting of lead, bismuth, indium, aluminum, gallium and tin or a mixture of several of these elements. The overall content of alloyed elements generally ranges from 100 to 1000 ppm. The alloyed element can be lead present in an amount ranging from 400 to 600 ppm. Associated alloy elements may be bismuth and indium, each present in a content ranging from 300 to 500 ppm, preferably from 350 to 450 ppm. Associated alloy elements can also be bismuth, indium and aluminum present at levels ranging from 50 to 150 ppm for bismuth, from 150 to 250 for indium and from 50 to 150 ppm for aluminum. The zinc alloy is generally used in the form of a powder. The mass of zinc alloy can represent from 5 to 95% of the mass of the coating. In general, it represents from 10 to 50%, preferably from 15 to 30% of the mass of the coating. The term “coating” here designates the mixture of compounds resulting from the drying of the paste, therefore after elimination of the water which is necessary for the formulation of the paste and for obtaining an adequate viscosity.

The zinc alloy can advantageously be mixed with zinc oxide ZnO. The zinc oxide allows to improve the performance of the cell in discharge. The zinc oxide preferably has a BET specific surface of at least 3 m²/g or at least 5 m²/g or at least 10 m²/g. A high specific surface allows to improve the chargeability of the cell. The mass of zinc oxide can represent from 90 to 50% of the mass of the coating. In general, it represents 70 to 85% of the mass of the coating. The mass ratio between zinc oxide and zinc alloy generally ranges from 2 to 4.

The nature of the binder is not limited. The binder is preferably a binder which is dispersible in an aqueous medium or which can form an aqueous solution. It may be a cellulosic compound or an elastomer or a thermoplastic compound. The cellulosic compound can be selected from methylcellulose (MC), carboxymethylcellulose (CMC), hydroxypropylmethylcellulose (HPMC), hydroxypropylcellulose (HPC) and hydroxyethylcellulose (HEC) and a mixture of several compounds among the latter. Preferably, it is hydroxypropyl methylcellulose (HPMC) because it provides better resistance of zinc to corrosion. The elastomer can be selected from a styrene/ethylene/butylene/styrene copolymer (SEBS), a butadiene copolymer, such as a styrene/butadiene copolymer (SBR), which is optionally carboxylated, a styrene/butadiene/vinylpyridine terpolymer (SBVR). The thermoplastic polymer can be a styrene-acrylate copolymer or an ethylene-vinyl acetate (EVA) copolymer. The binder can also be polyvinyl alcohol, optionally partially saponified. In a preferred embodiment, hydroxypropyl methylcellulose is mixed with a styrene/butadiene copolymer and polyvinyl alcohol. The binder can represent from 1 to 5% of the mass of the coating, preferably from 1 to 3%. Preferably, the coating does not contain a fluorinated polymer as a binder.

The coating may comprise one or more additives intended to reduce the corrosion of the zinc, other than mercury or derivatives of mercury. The additives may be intended to improve the dispersion of the constituents of the paste. The dispersing agent can be a polycarboxylic acid. Each additive is generally used at the rate of less than 1% by mass of the deposited coating. The coating may also contain one or more electronically conductive compounds.

A typical coating comprises:
from 5 to 45% or from 15 to 35% by mass of zinc alloy,
from 90 to 50% or from 80 to 60% by mass of zinc oxide,
from 0.1 to 5% or from 1 to 3% by mass of one or more binders,
from 0 to 1% by mass of one or more additives.

The paste electrode can be prepared by following the following procedure: A paste is produced by mixing water with one or more binders and with a zinc alloy powder, optionally previously mixed with a zinc oxide ZnO powder. The paste is kneaded. The paste can then be rested. The viscosity of the paste can be adjusted during mixing and after resting the paste by adding water. The viscosity of the paste can range from 30 Pa·s to 200 Pa·s for a temperature of 20° C. and at atmospheric pressure. The step of manufacturing the paste does not involve the addition of an alkaline solution, such as a KOH, NaOH, or LiOH solution. The paste is then deposited on one or both faces of the current collector. The support serving as a current collector can be two-dimensional such as a solid or perforated metal strip or an expanded metal or a grid. It can be three-dimensional such as felt or foam, made of metal or carbon. The thickness of the two-dimensional current collector is generally less than or equal to 100 μm. The current collector can be made of copper or nickel-plated steel.

Typically, the paste has a mercury or mercury compound content of less than or equal to 0.5%, or less than or equal to 0.2%, or less than or equal to 0.1%, or less than or equal to 0.01%. Preferably, it does not contain any.

The electrode obtained is dried in order to eliminate the water contained in the paste. The electrode is then rolled if necessary in order to adjust its thickness to the desired value. The paste electrode is thus obtained.

The positive electrode (cathode) may comprise at least one active material selected from the group consisting of silver, nickel, manganese dioxide and atmospheric oxygen. Silver and nickel are the preferred positive active materials. In the case of a silver electrode, that is in the form of a silver powder deposited on a support which is an expanded silver.

An electrochemical bundle is prepared by superimposing at least one cathode, at least one anode, separated by a separator. The separator can be based on polyolefin fibers that are untreated or treated with acrylic acid, or sulfonated, or based on polyamide fibers, or a cellophane which consists of cellulose hydrates. A membrane is generally inserted between an anode and a separator. This membrane has pores of smaller diameter than those of the separator. These pores are small enough to prevent the passage of zincate ions from the anode. The membrane is generally made of polyolefin or cellulose.

The electrochemical bundle is introduced into the container of the cell. The container can be of cylindrical or prismatic format. In the case of a cylindrical format, the electrodes are spiral. According to a preferred embodiment, the electrodes are planar and the format of the cell is prismatic. This format allows to obtain a cell with high power. The container is filled with an alkaline electrolyte, such as a solution of NaOH, KOH or LiOH or a mixture of several of these bases. Zinc oxide or a component containing tin can be added to the electrolyte. A reduction in the corrosion of the zinc anode, therefore a limitation of the loss of capacity has in fact been observed when these compounds are present in the electrolyte.

The cells comprising the paste electrode according to the invention can generally perform at least twenty cycles without observing a loss of capacity greater than 20% of their initial capacity.

### EXAMPLES

Four Ag—Zn type electrochemical cells were manufactured. These cells differ in the composition of their anode. Compositions A) to D) of the various anodes are described in Table 1. Composition A) contains 1 to 2% of mercury compound and serves as a reference. Compositions C) and D) are according to the invention. They either contain little mercury compound (composition D), or are free of mercury compound (composition C). Three different zinc alloy compositions C)1, C)2 and C)3 were tested. The anode of the four cells contains 2% by mass of binder. Table 1 compares the corrosion rate and mercury-related toxicity of electrochemical cells made with anodes of composition A to D.

TABLE 1

| | Corrosion | | |
|---|---|---|---|
| Composition | rate | Toxicity | Comments |
| A) Zn + 1-2% Hg* | + | −− | Acceptable corrosion |
| | | | rate but high toxicity |
| B) Zn + 0% Hg* | − | + | High corrosion rate − |
| | | | loss of capacity/low |
| | | | electrical performance |
| C) alloyed Zn + 0% Hg | ++ | ++ | No mercury-related |
| (Three tested | | | toxicity and acceptable |
| alloy compositions | | | corrosion |
| C)1, C)2 and C)3) | | | |
| D) alloyed Zn + <0.5% | + | + | Reduction of toxicity |
| mercury compound | | | related to the reduction |
| | | | of the amount of |
| | | | mercury and acceptable |
| | | | corrosion |

*outside the invention

The composition of the zinc alloy used in the four anodes containing little or no mercury is detailed in Table 2 below.

TABLE 2

| | Composition of the zinc alloy |
|---|---|
| D) | Zn + 400-600 ppm lead |
| C)-1 | Zn + 400-600 ppm lead |
| C)-2 | Zn + 370-430 ppm bismuth + |
| | 370-430 ppm indium |
| C)-3 | Zn + 75-125 ppm bismuth + |
| | 170-230 ppm indium + |
| | 70-130 ppm aluminum |

The cathodes are identical in these four cells A) to D). This is an electrode comprising an expanded silver on which a silver powder is deposited. The amount of silver in the cathode is calculated to correspond to a capacity equal to 1.3 times the capacity of the anode. The capacity of the cell is therefore limited by the cathode.

The cells were subjected to a cycling test comprising the following phases:
charging at a constant current of C/10 until a voltage of 1.95 V was reached, then charging at a constant current of C/20 until a voltage of 2.08 V was reached;
discharging at a current of 4 C up to 80% state of discharge.

Every five cycles, a discharge to 100% depth of discharge at a rate of 4 C is carried out in order to measure the capacity of the cell.

Results:

a) Corrosion Rate:

Measurements of the volume of gas released by the cells during cycling were carried out. The volume of gas released by the cells is correlated to the corrosion rate of the anode. The capacity of the cells was also measured during the cycling of the cells. The results obtained on cells C) and D) were compared with those obtained on cell A). Compared to cell A), cells C) and D) have lower toxicity due to the reduction in the amount of mercury. They nevertheless retain a reduced corrosion rate.

b) Capacity Discharged During Cycling:

The capacity discharged during cycling by the cells comprising the mercury-free electrodes C)1, C)2 and C)3 was compared with that discharged by the cell including an electrode D) containing little mercury. The discharged capacity values are given in Table 3 at different times of cycling.

TABLE 3

| | Discharged capacity relative to electrode | | | | |
|---|---|---|---|---|---|
| | D) with little mercury (%) | | | | |
| | Cycle nº5 | Cycle nº10 | Cycle n°15 | Cycle nº20 | Cycle nº25 |
| Mercury-free | +4.7 | +6.7 | +3.3 | +3.8 | +4.1 |
| electrode C)1 | | | | | |
| Mercury-free | +2.0 | +2.2 | 0 | +2.9 | +1.0 |
| electrode C)2 | | | | | |
| Mercury-free | 0 | +3 | +1 | +3.8 | 0 |
| electrode C)3 | | | | | |

Table 3 shows that the capacity of the cells containing the mercury-free anodes of composition C)1, C)2, C)3 is not lower than that of the cell whose anode contains little mercury. The mercury-free electrodes according to the invention, with the zinc alloy compositions according to C)1 or C)2 or C)3, therefore have discharge performance that is as good, or even better, than that of the cell containing the electrode with little mercury according to the invention.

c) Charge and Discharge Voltage:

A measurement of the voltage of the cell containing the mercury-free electrode C)1 was carried out when the cell is used for charging and discharging. The voltage values are comparable to those obtained for the cell containing the electrode D) with little mercury.

These results show that the cells comprising a mercury-free electrode have performances at least equivalent to those obtained on an electrode with little mercury, whether in terms of service life, discharged capacity or charge and discharge voltage levels. The invention allows to produce an electrochemical cell comprising alkaline electrolyte capable of supplying high power.

1. A paste electrode comprising a current collector support, which is coated on at least one of its faces with a coating composed of a composition comprising:
an active material comprising zinc alloyed with one or more chemical elements,
one or more binders.

2. The paste electrode according to claim 1, wherein the mass of zinc alloy represents from 5 to 95% of the mass of the coating.

3. The paste electrode according to claim 1, wherein the mass of zinc alloy represents from 10 to 50%, preferably from 15 to 30% of the mass of the coating.

4. The paste electrode according to claim 1, wherein the active material further comprises zinc oxide ZnO.

5. The paste electrode according to claim 4, wherein the mass of zinc oxide represents from 90 to 50%, preferably from 70 to 85% of the mass of the coating.

6. The paste electrode according to claim 4, wherein the zinc oxide has a BET specific surface of at least 3 m²/g.

7. The paste electrode according to claim 1, wherein the coating contains at most 0.5% by mass of mercury or mercury compound.

8. The paste electrode according to claim 7, wherein the coating is free of mercury or mercury compound.

9. The paste electrode according to claim 1, wherein the zinc is alloyed with at least one element selected from the group consisting of lead, bismuth, indium, aluminum, gallium, tin and a mixture of several of these elements.

10. The paste electrode according to claim 1, wherein the binder is a cellulosic compound or a rubber of the styrene-butadiene type or a mixture of a cellulosic compound and a rubber of the styrene-butadiene type.

11. The paste electrode according to claim 1, wherein the coating further comprises at least one surfactant.

12. The paste electrode according to claim 4, wherein the coating comprises:
from 5 to 45% by mass of zinc alloy,
from 90 to 50% by mass of zinc oxide,
from 0.1 to 5% by mass of one or more binders.

13. The paste electrode according to claim 1, wherein the current collector support is a strip of copper or nickel-plated steel.

14. An electrochemical cell comprising an alkaline electrolyte, at least one cathode and at least one anode which is the paste electrode as defined in claim 1.

15. The electrochemical cell according to claim 14, wherein the cathode comprises at least one active material selected from the group consisting of silver, nickel, manganese dioxide and atmospheric oxygen.

16. The electrochemical cell according to claim 14, wherein the alkaline electrolyte comprises zinc oxide or tin or a mixture of both.

17. The electrochemical cell according to claim 15, the container of which is of prismatic format.
